(19) United States
(12) Patent Application Publication
(10) Pub. No.: US 2015/0186607 A1
(43) Pub. Date: Jul. 2, 2015

(54) CLINICAL SUPPORT SYSTEM AND METHOD

(71) Applicant: KONINKLIJKE PHILIPS N.V., EINDHOVEN (NL)

(72) Inventors: Gijs Geleijnse, Geldrop (NL); Aleksandra Tesanovic, Eindhoven (NL); Jan Johannes Gerardus De Vries, Eindhoven (NL)

(73) Assignee: KONINKLIJKE PHILIPS N.V., EINDHOVEN (NL)

(21) Appl. No.: 14/421,182

(22) PCT Filed: Aug. 23, 2013
(86) PCT No.: PCT/IB2013/056838

§ 371 Date: Feb. 12, 2015

Related U.S. Application Data
(60) Provisional application No. 61/692,737, filed on Aug. 24, 2012.

(30) Foreign Application Priority Data
Aug. 24, 2012 (EP) 12181644.1

(51) Int. Cl. G06F 19/00; G06Q 50/22

(52) U.S. Cl. CPC G06F 19/345; G06Q 50/22

(57) ABSTRACT

The present invention relates to a clinical support system and a corresponding clinical support method. The system comprises a processor and a computer-readable storage medium, wherein the computer-readable storage medium contains instructions for execution by the processor, wherein the instructions cause the processor to perform the steps of obtaining current patient data descriptive of a patient, for whom a recommendation for a transition from a current care levels to one or more other care levels shall be provided, in the current care level, obtaining historic patient data of the patient obtained earlier in the current and/or other care levels.

### FIELD OF THE INVENTION

The present invention relates to a clinical support system comprising a processor and a computer-readable storage medium, wherein the computer-readable storage medium contains instructions for execution by the processor. Further, the present invention relates to a clinical support method, a computer-readable non-transitory storage medium and a computer program.

### BACKGROUND OF THE INVENTION

The level and place of care for a patient should fit his condition. Obviously, the higher the level of care, the larger the associated costs. Therefore, it is important to monitor the patient's condition and adjust the level of care accordingly.

Where the transition of care is determined by the treating physicians, there is a growing need for evidence-based decision support for care transitions. In current products of the applicant, such as IntelliVue Guardian and Visicu, an Early Warning Score is applied for the deterioration of the patient. This score is based on the deterioration of the current phase of the patient's hospitalization, either in the ICU or on the observatory ward.

### SUMMARY OF THE INVENTION

It is an object of the present invention to provide a clinical support system and a clinical support method that better assist a clinician to plan resources and to tailor care of a patient.

In a first aspect of the present invention a clinical support system is presented comprising a processor and a computer-readable storage medium, wherein the computer-readable storage medium contains instructions for execution by the processor, wherein the instructions cause the processor to perform the steps of:
obtaining current patient data descriptive of a patient, for whom a recommendation for a transition from a current care levels to one or more other care levels shall be provided, in the current care level,
obtaining historic patient data of the patient obtained earlier in the current and/or other care levels, and
computing two or more patient specific transition scores from said obtained current and historic patient data, wherein a patient specific transition score indicates a level of recommendation of a transition of the patient from the current care level to a different care level or to stay in the current care level.

In a further aspect of the present invention a corresponding clinical support method is presented.

In yet other aspects of the present invention, there are provided a computer program which comprises program code means for causing a computer to perform the steps of the processing method when said computer program is carried out on a computer, and a computer-readable non-transitory storage medium containing instructions for execution by a processor, wherein the instructions cause the processor to perform the steps of the claimed clinical support method.

Preferred embodiments of the invention are defined in the dependent claims. It shall be understood that the claimed method, computer program, and computer-readable non-transitory storage medium have similar and/or identical preferred embodiments as the claimed system and as defined in the dependent claims.

Compared to known systems and methods, according to the present invention a broader outlook for the patient is provided, as the conventionally used scores are solely based on the current condition of the patient. By providing a prediction of the recovery of the patient and his prognosis for the next period, the clinician can be better assisted to plan resources and tailor care.

Thus, an evidence-based decision support is provided by the present invention to assist the clinician to make educated decisions on the transition of the patient to a different level of care (or to better stay in the current level of care). Contrary to known solutions, these decision recommendations are based on longitudinal historic patient data and, preferably, predication models.

The proposed clinical support system and method thus preferably assesses the patient's health progress throughout the entire care cycle (generally until palliative care is provided) from ICU (Intensive Care Unit), general ward to the home. Based on past transitions—both improvements and deteriorations—recommendations (in the form of the two or more transition scores) are generated for a transfer to a different (or the same) level of care. Hence, these recommendations are at least based on at least some information from the medical past (e.g. information just from before admission to the current care level) and the current situation of the patient. Optionally, further useful parameter to be used in determining these recommendations are the risk of readmission to the current care level (care facility), the health status and progression during the current stay and predicted health status values. Preferably, these recommendations are not only based on data collected in the current care unit, but also on data in previous care units. The proposed clinical support system and method can be applied throughout the entire care cycle from ICU to General Ward to out-patient settings such as nursing facilities and the home.

In one aspect the invention provides for a clinical support system. A clinical support system as used herein encompasses an automated system which facilitates the management of a patient pathway or care plan. The clinical support system comprises a processor and a computer-readable storage medium.

A ‘computer-readable storage medium’ as used herein encompasses any storage medium which may store instructions which are executable by a processor of a computing device. The computer-readable storage medium may be referred to as a computer-readable non-transitory storage medium. The computer-readable storage medium may also be referred to as a tangible computer readable medium. In some embodiments, a computer-readable storage medium may also be able to store data which is able to be accessed by the processor of the computing device. An example of a computer-readable storage medium include, but are not limited to: a floppy disk, a magnetic hard disk drive, a solid state hard disk, flash memory, a USB thumb drive, Random Access Memory (RAM) memory, Read Only Memory (ROM) memory, an optical disk, a magneto-optical disk, and the register file of the processor. Examples of optical disks include Compact Disks (CD) and Digital Versatile Disks (DVD), for example CD-ROM, CD-RW, CD-R, DVD-ROM, DVD-RW, or DVD-R disks. The term computer readable-storage medium also refers to various types of recording media capable of being accessed by the computer device via a network or communication link. For example a data may be retrieved over a modem, over the internet, or over a local area network.

A ‘processor’ as used herein encompasses an electronic component which is able to execute a program or machine executable instruction. References to the computing device comprising ‘a processor’ should be interpreted as possibly containing more than one processor. The term computing device should also be interpreted to possibly refer to a collection or network of computing devices each comprising a processor. Many programs have their instructions performed by multiple processors that may be within the same computing device or which may even distributed across multiple computing device.

The ‘care level’ indicates the level at which care is taken of a patient, such as ICU, general ward, home, different stations of a hospital. Other terms used herein or generally in the art indicating the ‘care level’ are ‘level of care’, ‘care facility’, ‘care area’, ‘care location’, ‘care setting’, or ‘care unit’. Hence, when any of these terms is used herein it shall be understood as a synonym for ‘care level’ or at least as an indicator for the ‘care level’.

In a preferred embodiment the instructions further cause the processor to compute said two or more patient specific transition scores by use of a prediction model predicting the patient's future health progress based on said obtained current and historic patient data. There are various prediction models known that could be used, for instance admission risk models (e.g. a home risk model as e.g. described in Murata G H, Gorby M S, Kapsner C O, Chick T W, Halperin A K, “A multivariate model for predicting hospital admissions for patients with decompensated chronic obstructive pulmonary disease”, Arch Intern Med. 1992, January; 152(1):82-6), disease severity/diagnosis models (as e.g. described in Richard W Troughton, Christopher M Frampton, Timothy G Yandle, Eric A Espine, M Gary Nicholls, A Mark Richards, “Treatment of heart failure guided by plasma aminoterminal brain natriuretic peptide {(N-BNP)} concentrations”, The Lancet, Volume 355, Issue 9210, Pages 1126-1130, 1 Apr. 2000), or models on HF development such as HFSS (Heart Failure Severity Score) or Framingham Heart Failure model as e.g. described in Kannel W B, D'Agostino R B, Silbershatz H, Belanger A J, Wilson P W, Levy D, “Profile for estimating risk of heart failure”, Arch Intern Med. 1999 Jun. 14; 159(11):1197-204. Further, models predicting readmission and/or mortality risks can be used, including, but not limited to, those of described in Keenan P S, Normand S L, Lin Z, Drye E E, Bhat K R, Ross J S, Schuur J D, Stauffer B D, Bernheim S M, Epstein A J, Wang Y, Herrin J, Chen J, Federer J J, Mattera J A, Wang Y, Krumholz H M, “An administrative claims measure suitable for profiling hospital performance on the basis of 30-day all-cause readmission rates among patients with heart failure”, Circ Cardiovasc Qual Outcomes. 2008 September; 1(1):29-37, Amarasingham R, Moore B J, Tabak Y P, Drazner M H, Clark C A, Zhang S, Reed W G, Swanson T S, Ma Y, Halm E A, “An automated model to identify heart failure patients at risk for 30-day readmission or death using electronic medical record data”, Med Care. 2010 November; 48(11):981-8, or Tabak Y P, Johannes R S, Silber J H, “Using automated clinical data for risk adjustment: development and validation of six disease-specific mortality predictive models for pay-for-performance”, Med Care. 2007 August; 45(8):789-805. The description of these models in the cited publications is herein incorporated by reference.

In another embodiment said historic patient data comprises historic transitions between different care levels including information on improvements and/or deteriorations of the patient's health status in response to said historic transitions. In other words, patient specific data from the past, e.g. how the patient's health developed in the past following a transition to a different care level are taken into account to further improve the reliability and accuracy of the determination of the transition scores.

Preferably, said current patient data comprises changes of the patient's health status in the current care level. For instance, an improvement of the patient's health status in the current care level may be an indication that the patient could be transferred into a less intensive care level or could stay in the same care level, but should not be transferred into a more intensive care level.

In an embodiment the instructions further cause the processor to identify the location of the current care level and to use the location of the current care level as an additional input in the computation of the two or more patient specific transition scores. The location is used to determine the care facilities to be evaluated. For example, some care transitions (ICU to home) will, more or less, never occur. The location of the current care level is also used to determine the data available and the frequency of assessing the patient (i.e. computing the transition scores). For higher care levels this frequency will be higher.

Preferably, the instructions further cause the processor to identify the location of the current care level by reading a location information from the current patient data or by deriving the location from features of the current patient data including the type, amount and/or content of the current patient data.

In an advantageous embodiment the instructions further cause the processor to use the risk of readmission of the patient to the current care level as an additional input in the computation of the two or more patient specific transition scores. The risk of readmission generally means the chance that the patient will return to the current level of care after discharge to a lower care level. An example of a readmission risk model is described in Amarasingham et al, “An Automated Model to Identify Heart Failure Patients at Risk for 30-Day Readmission or Death Using Electronic Medical Record Data”, Medical Care: November 2010—Volume 48—Issue 11—pp 981-988. The risk of readmission (e.g. in the form or a readmission score) can, for instance, be directly taken as the transition score or can be combined with an alternative score using a weighted sum.

The instructions further preferably cause the processor to use a risk model describing the risk of readmission of the patient to the current care level. Such risk models are generally known, e.g. from B. Hammill, L. Curtis, G. Fonarow, P. Heidenreich, C. Yancy, E. Peterson, and A. Hernandez, “Incremental value of clinical data beyond claims data in predicting 30-Day outcomes after heart failure hospitalization,” Circulation: Cardiovascular Quality and Outcomes, vol. 4, no. 1, pp. 60-67, January 2011, Harlan M. Krumholz et al., “Predictors of readmission among elderly survivors of admission with heart failure”, American Heart Journal, Volume 139, Issue 1, Pages 72-77, January 2000, or Philbin E F, DiSalvo T G, “Prediction of hospital readmission for heart failure: development of a simple risk score based on administrative data”, J Am Coll Cardiol. 1999 May;33(6):1560-6.

In an embodiment the instructions further cause the processor to use patient population data providing statistical information on historic transitions of other patients between different care levels including information on improvements and/or deteriorations of their health status in response to said historic transitions. Thus, statistical data how a larger number of patients developed in the past, preferably of patients having the same disease(s) and/or health status, are used in the generation of the patient specific transition scores to further improve their reliability and accuracy.

In another embodiment the instructions further cause the processor to compute one or more disease specific health scores for the patient from said current and historic patient data and to use said one or more disease specific health scores in the computation of said two or more patient specific transition scores. The generation and use of such health scores are generally known, e.g. from Subbe C. P. et al., “Validation of a modified Early Warning Score in medical admissions”, QJM (2001) 94 (10): 521-526. doi: 10.1093/qjmed/94.10.521, and further improves the reliability and accuracy of the generated patient specific transition scores.

Preferably, the instructions further cause the processor to obtain patient data, health progression information and/or transmission scores of patients that had the same or a similar health status and/or health history as the current patient and to use the obtained patient data health progression information and/or transmission scores in the computation of the two or more patient specific transition scores. Thus, not only data about the current patient, but also historic data about other patients, preferably with the same or similar health status and/or patients that have been in the same care level, and their health progression in the past, for instance in response to a transition to a different care level or in response to a decision to stay in the same care level, are used to determine the actual patient specific transition scores.

In a preferred embodiment the instructions further cause the processor
to compute a general health score for the current care level from historic patient data of patients that have been in the current care level,
to compute two or more general transition scores each indicating a level of recommendation of a transition of a patient from the current care level to a different care level or to stay in the current care level, and
to combine said two or more general transition scores with said two or more patient specific transition scores to obtain two or more final transition scores.

Thus, not only transition scores for the current patient but also for other patients (based on historic data) transition scores are computed to avoid that the patient specific transition scores are wrong due to any mistake, e.g. a misinterpretation of any data, a computation error or any other problem. This can be recognized from a comparison with the general transition scores, e.g. if it shows that the patient specific transition scores are rather different from the general transition scores.

Preferably, the instructions further cause the processor to apply a weighted combination of said general transition scores and said patient specific transition scores to obtain said final transition scores, the weights being determined manually or from the accuracy of past transition scores of the current patient, other patients and/or all patients.

### BRIEF DESCRIPTION OF THE DRAWINGS

These and other aspects of the invention will be apparent from and elucidated with reference to the embodiment(s) described hereinafter. In the following drawings

FIG. 1 shows a diagram generally illustrating a transition model,

FIG. 2 shows a diagram illustrating the transition scores for the transition model depicted in FIG. 1,

FIG. 3 shows a schematic diagram of a first embodiment of the proposed clinical support system,

FIG. 4 shows a flowchart of a first embodiment of the proposed clinical support method,

FIG. 5 shows a schematic diagram of a second embodiment of the proposed clinical support system,

FIG. 6 shows a flowchart of a second embodiment of the proposed clinical support system.

### DETAILED DESCRIPTION OF THE INVENTION

The proposed clinical support system and method utilizes current and historic patient data. These patient data may be collected through patient monitors (e.g. ECG, pulse oximeter, thermometer, . . . ), other (near) real-time measuring devices such as weight scales or lab tests, as well as electronically stored patient data. For instance, an EHR (Electronic Health Record) may be used that contains a structured description of the patient's current condition as well as historic data about earlier diseases, diagnosis, therapies, health progression, etc.

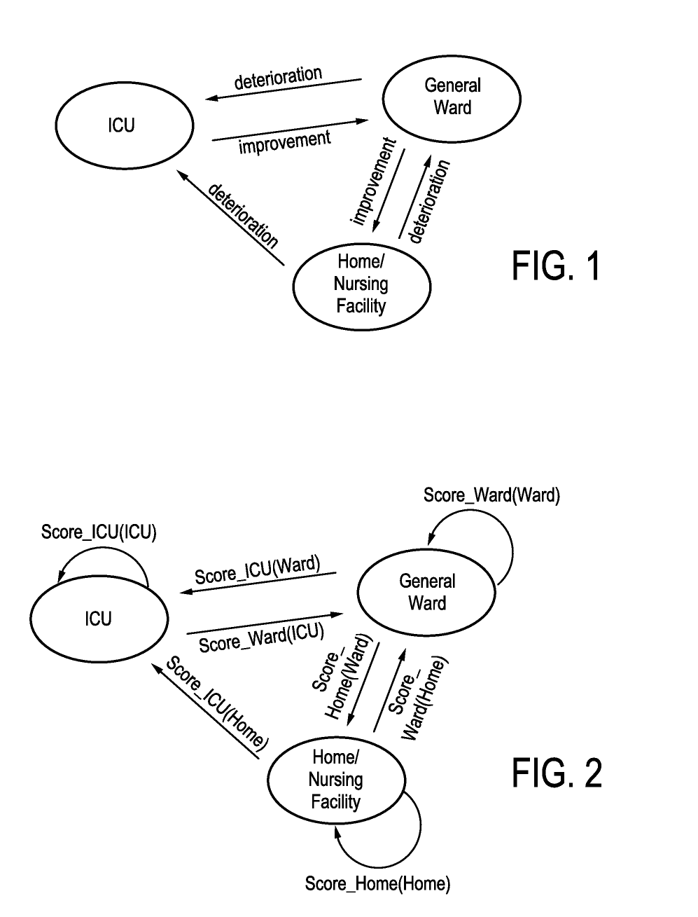

A clinical support system and method, which may also be part of a complete health management system and method as used by clinicians, may comprise many different functions and aspects. The proposed clinical support system and method focuses on recommendations for the transition of a patient to a different care level (or care facility). This can be a higher level of care, because of a deterioration of the patient's condition. Alternatively, an improvement may lead to a lower care level. A diagram of a typical transition model is depicted in FIG. 1, where the home, the ICU (Intensive Care Unit) and the General Ward are taken as example care areas (i.e. care levels). The possible transitions from one unit to the other are modeled. Hence, given the location of the patient, the clinical pathway is known. In the example of FIG. 1, no direct transition from the ICU to the home is taken into account.

To compute recommendations for transitions from one care facility (i.e. care level) to the other, patient specific transition scores are computed for several (preferably each) possible transition. These transition scores (called “score_X (Y)” where “X” indicates the destination care level and “Y” indicates the current care level) are exemplarily shown in FIG. 2 depicting the transition model of FIG. 1. Per care level, the sum of the transition scores for all outgoing arrows is 1. These scores may separately be presented to the clinician or they may be translated into a single recommendation to which care level this particular patient should be transferred.

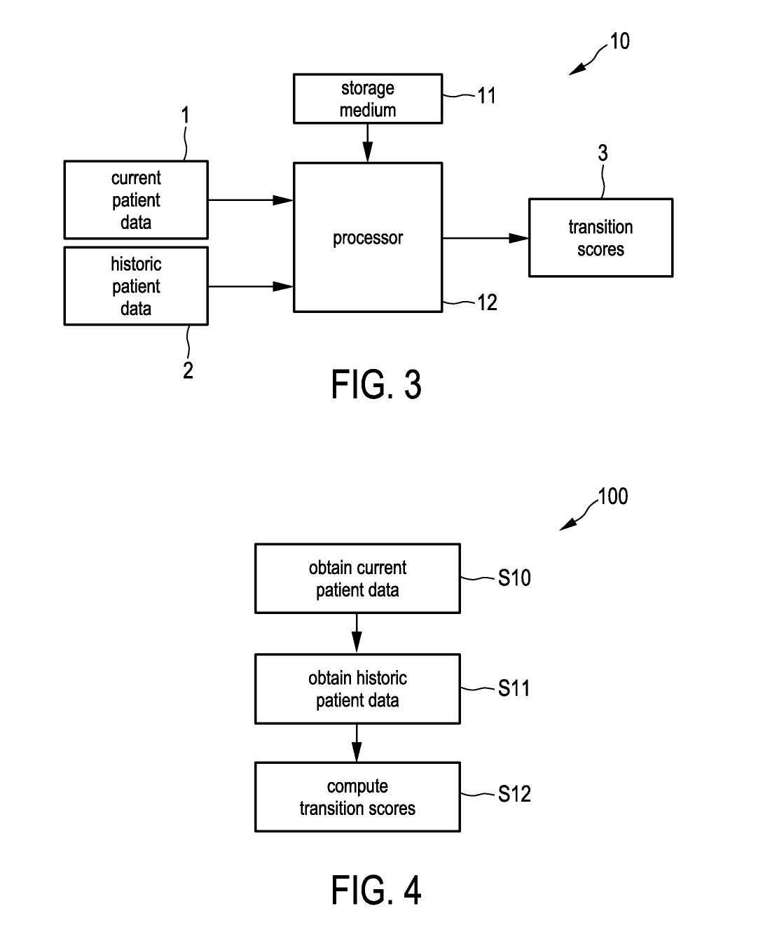

FIG. 3 shows a schematic diagram of a first embodiment of a clinical support system 10 according to the present invention. It comprises a processor 11 and a computer-readable storage medium 12. The computer-readable storage medium 12 contains instructions for execution by the processor 11. These instructions cause the processor 11 to perform the steps a clinical support method 100 as illustrated in the flow chart shown in FIG. 4.

In a first step S10 current patient data 1 descriptive of a patient, for whom a recommendation for a transition from a current care levels to one or more other care levels shall be provided, are obtained in the current care level. In a second step S11 historic patient data 2 of the patient obtained earlier in the current and/or other care levels are obtained. In a third step S12 two or more patient specific transition scores 3 are computed from said obtained current patient data 1 and historic patient data b 2, wherein a patient specific transition score indicates a level of recommendation of a transition of the patient from the current care level to a different care level or to stay in the current care level.

Thus, the current patient status (indicated in the current patient data) as well as the historic data on the particular patient form the basis to compute the patient specific transition scores for several (preferably all) possible transitions from the current care unit. The historic patient data describes not only the data collected in the current care unit, but also the data collected in previous care settings (i.e. care levels). Although the monitoring devices may differ and the health scores may be based on different algorithms, this provides a longitudinal overview of the patient's health (i.e. a long-term overview or an overview based on the current status as well as the disease/health progression based on data collected in a plurality of care levels). This overview is preferably used to predict future care transitions and to compute transition scores indicating to which care level a transition is more recommendable and to which care level a transition is less recommendable.

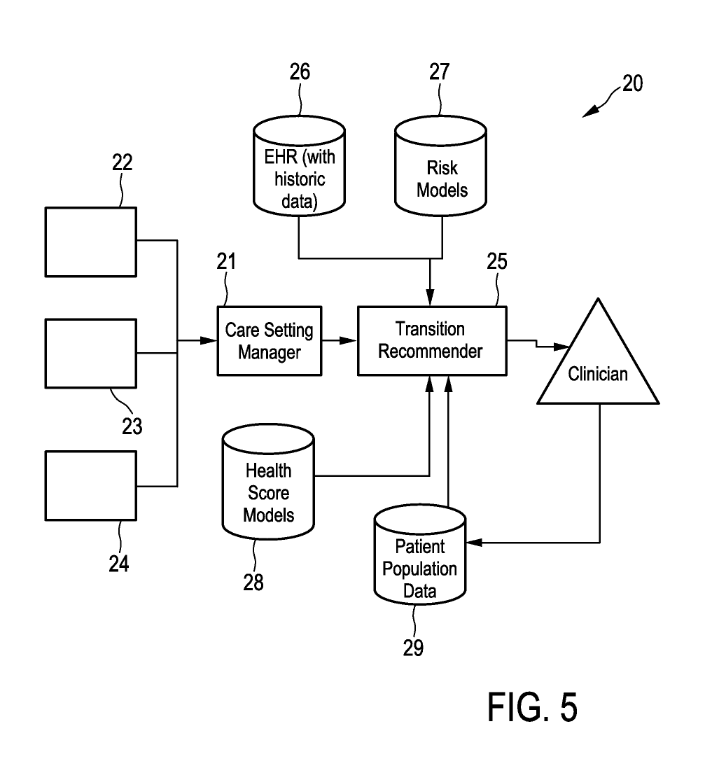

FIG. 5 illustrates a schematic diagram of another embodiment of the proposed clinical support system 20. It comprises a means 21 for obtaining the current patient data (called “Care Setting Manager” in this embodiment). This Care Setting Manager 21 manages the context of the patient, i.e. determines the current location and level of care. This component collects measurements done with sensor device 22, 23, 24 that are used to monitor the patient. The location of the patient may be one of its inputs.

It is notable that in the different care settings, different combinations of measuring devices are generally used. For example, while in the ICU a broad range of monitors with streaming data is available, in the home only daily (or weekly) samples of a small set of measurements will be collected. The proposed clinical support system, however, is able to deal with patient data obtained in different formats, at different locations, at different times and/or from different measurement devices. For instance, used models are tailored to the data available in the setting to provide support throughout the care cycle.

Having determined the location of the patient, the main computing component 25 (called “Transition Recommender” in this embodiment) determines the scores for all transitions, where a stay in the current care facility is also modeled as a transition.

The Care Setting Manager 21 collects the data streams for the patient and identifies the location of care. This identification is done by explicit input or labeling (e.g.

hospital name, care unit or ward ID) or implicitly by a derivation of the obtaining data.

The Transition Recommender 25 computes, based on the care setting, recommendations for transitions to other care settings. These recommendations are preferably computed on a frequency associated with the care setting, i.e. the higher the care level, the more often these recommendations will be computed. The recommendations are based on a combination of data sources, i.e. at least from the collected monitoring data and additional patient data (e.g. retrieved by the Transition Recommender 25 that may include a separate means for obtaining the additional patient data, from a data base 26 storing an EHR of the patient). Further preferably, risk models 27 that describe the risk of readmission to the current care setting, health score models 28 and/or patient population data 29 that are used to generate statistical evidence on likely transitions and prognosis of readmission are used in addition.

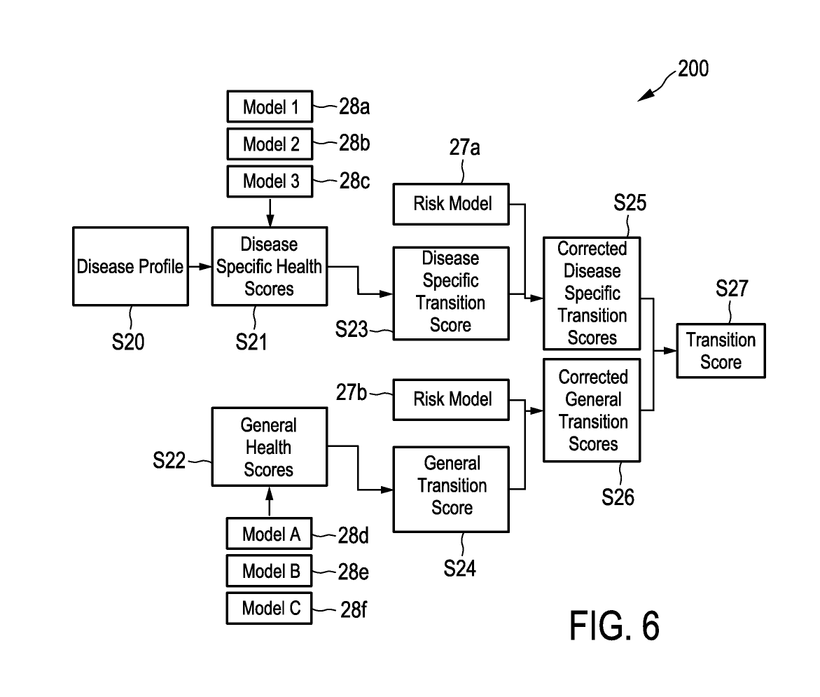

Per patient and per care facility (e.g. ICU, general ward and home) the embodiment of the clinical support method 200 as depicted in FIG. 6 may be used at a predetermined rate. It shall be noted that in other embodiments not all elements of the clinical support method 200 are use, and a selection of the depicted elements may also be used in other combinations.

To select the proper algorithms for the patient, a profile is generated for the patient in step S20 (“Disease Profile”). This profile comprises an overview of many (preferably all) current diseases of the patient. These diseases are extracted from an EHR of the patient that is e.g. stored in a data base (e.g. the data base 26 shown in FIG. 5), either based on structured data (e.g. the ICD-10 codes), the diagnosis and admission details in natural language or derived using a combination of symptoms, medication, lab values and other evidence that supports diagnosis. Hence, zero or more current diseases are associated with the patient. Moreover, these diseases are preferably weighted based on the classification in the EHR (i.e. primary, secondary diagnosis, or based on the main symptoms at admission). If at least one disease has been identified, it is assumed that the sum of all disease weights equals 1.

Using the data collected in step S20, the health score of the patient is computed based on disease-specific and care-setting specific health scores (related to the criticality of the condition and the need for care/support) in step S21 (“Disease-specific health scores”). For example, the current health score of a Heart Failure patient in the home may be determined by the progress of their weight (signaling fluid retention). The health score of a Heart Failure patient in the hospital may be expressed as their progress towards discharge (e.g. by applying the HFSA guidelines or computing a disease-specific mortality score). Now, having a selection of diseases, each associated with one or more risk models, several (e.g. all) health score models 28a, 28b, 28c are evaluated with the monitored patient data as well as with the information available in the EHR. This leads per disease to a selection of health scores either expressing health states or health improvements (e.g. discharge readiness, patient stability, symptom assessment score) or expressing risk of a sudden adverse event (e.g. hospital mortality scores).

Using a predefined combination of weights, these computed health scores are combined into a single disease specific health score per disease. Finally, all combined disease specific health scores are merged into a single health score using the weights derived in step S20.

Preferably, these health scores are continuously computed with fixed time intervals. Alternatively, the severity of the patient condition may increase the number of evaluation moments (viz. IntelliVue Guardian, which is a product in which the frequency of evaluations of the EWS is increased when the patient condition is more severe).

Apart from disease specific health scores, general (overall) health scores may be used as well as obtained in step S22, preferably by use of health score models 28d, 28e, 28f.

Based on the data available in the current care setting, the health scores are computed when possible. Data monitored using sensors, extracted from the EHR or derived from questionnaires, can be used to assess the patient's overall health condition. For example, for the ICU the known MEWS (Modified Early Warning Score) may be used to assess the patient's health, while a Quality of Life questionnaire and Physical Activity measurements are more applicable in the home setting.

For both the general health score path as well as the disease specific health score path, risk models 27a, 27b may be applied. These risk models 27a, 27b predict the risk of an early readmission to the current level of care. Both for the ICU as well as for hospitalization, such models are commonly available. Such models may be disease specific (e.g. Acute Myocardial Infarction, Pneumonia, Heart Failure) or generic. Both for the general as well as for the disease specific case, the models (for which sufficient data is available) are weighted into combined risk scores. When the risk models 27a, 27b also include a measure for their confidence (e.g. standard deviation of the model when applied to a population), these measures can be formed into a weight factor as well and integrated into the combination of risk scores.

It shall be noted that for the lowest level of care (i.e. the home), no readmission risk scores are applicable, but risk scores are used to predict transitions to higher care levels. In step S23 (“Disease Specific Transition Score”) trend-based transition scores for the next period of time are computed. Preferably, a combination of both the disease specific as well as the generic patient scores is computed. Based on the progression in the current stay in the care unit and the health progression in the past care units the probability of transitions are computed by matching historic transition score data with actual transitions to other care facilities. For the historic data, data from the patient himself as well as historic data from patients with a similar profile (i.e. similar co-morbidities, the same care level and a similar progression of vital signs and other health markers) are used. Based on these matching algorithms, the probability for each possible transition is computed.

In step S24 (“General Transition Score”) the general transition score is computed in a similar fashion as the disease specific transition score in step S23. Hence, historic general health scores are matched with actual transitions to predict probabilities of each possible transition. Not only the health scores collected in the current care unit are taken into account, but also the transition scores in previous care units.

The disease specific transition scores computed in steps S23 and S24 may be fine-tuned using the risk of early readmission to the current care unit in steps S25 (“Corrected Disease Specific Transition Score”) and S26 (“Corrected General Transition Score”). For higher risk scores, the transitions for lower levels of care are lowered, while the score for remaining in the care unit is increased. Secondly, if the patient has experienced early readmissions in the past, the transition scores are corrected in a similar fashion.

A weighted combination of the two transition scores is taken to compute the final transition scores in step S27 (“Transition Score”). These weights may either be manually determined, or may be based on the accuracy of past predictions of the patient, or may be based on the accuracy of past predictions of similar patients, or may be based on the accuracy of all patients in the database.

Each moment a new set of transition scores is computed, this may be fed into a clinical application. This clinical application may output a recommendation (based on the highest ranked transition score), e.g. show it on a display. Alternatively, several or all transition scores for several or all transitions may be output. Finally, the clinician may receive insight into the patient's health progress by outputting (e.g. displaying) the transition scores over time.

The proposed clinical support system and method are applicable to a broad range of clinical domains, where patient data available, e.g. collected through monitors and electronic records. Thus, they particularly target the care transition cycle of chronic patients.

To illustrate a practical implementation the situation in the ICU shall be assumed, where a Modified Early Warning Score (MEWS, as currently e.g. described at http://qjmed.oxfordjournals.org/content/94/10/521.short) is typically used to grasp the status of the patient. This MEWS can be used for the two transition scores score_icu and score_ward, where score_icu=“percentage of time in last 24 hours that the patient's MEWS score was below 6” and score_ward=“percentage of time in last 24 hours that the patient's MEWS score was at least 6”. If the patient is admitted to the ICU with heart failure, then the disease progression can be expressed using the weight loss of the patient (due to diuretic treatment to remove fluids build-up in the lungs and other body parts). To this end, the initial weight w_i, the target weight w_t (set by clinician) and the current weight w_c are observed. A personalized, disease specific transition score might then be:

Score_icu=α×“percentage of time in last 24 hours that the patient's MEWS score was

$$below 7 ” + ( 1 - α ) \times \frac{{w}_{i} - {w}_{c}}{{w}_{i} - {w}_{t}}$$

$$Score\_ward = 1 - score\_icu ,$$

wherein α is a pre-set value between 0 and 1.

In summary, for both patients and care providers, it is essential that the level of care fits the current and future health condition of the patient. Nowadays, clinical decision support solutions typically focus on early detection of adverse events, based on data collected during the current care unit (e.g. ICU, general ward, home). There is a need for evidence-based decision support for future transitions to other care levels, either higher (e.g. from the general ward to the ICU) or lower (e.g. from the ward to a nursing facility). The proposed clinical support system and method compute recommendations for care transitions. By taking the patient's current and historic (and, preferably, predicted) condition into account, recommendations are obtained for each possible care transition. By measuring, tracking and modeling the patient's condition over various care settings, evidence is collected to create personalized care transition recommendations.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program may be stored/distributed on a suitable non-transitory medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. A clinical support system comprising a processor and a computer-readable storage medium, wherein the computer-readable storage medium contains instructions for execution by the processor, wherein the instructions cause the processor to perform the steps of:
obtaining current patient data descriptive of a patient, for whom a recommendation for a transition from a current care levels to one or more other care levels shall be provided, in the current care level,
obtaining historic patient data of the patient obtained earlier in the current and/or other care levels, and
computing two or more patient specific transition scores from said obtained current and historic patient data, wherein a patient specific transition score indicates a level of recommendation of a transition of the patient from the current care level to a different care level or to stay in the current care level.

2. The clinical support system as claimed in claim 1, wherein the instructions further cause the processor to compute said two or more patient specific transition scores by use of a prediction model predicting the patient's future health progress based on said obtained current and historic patient data.

3. The clinical support system as claimed in claim 1, wherein said historic patient data comprises historic transitions between different care levels including information on improvements and/or deteriorations of the patient's health status in response to said historic transitions.

4. (canceled)

5. The clinical support system as claimed in claim 1, wherein the instructions further cause the processor to identify the location of the current care level and to use the location of the current care level as an additional input in the computation of the two or more patient specific transition scores.

6. The clinical support system as claimed in claim 5, wherein the instructions further cause the processor to identify the location of the current care level by reading a location information from the current patient data or by deriving the location from features of the current patient data including the type, amount and/or content of the current patient data.

7. The clinical support system as claimed in claim 1, wherein the instructions further cause the processor to use the risk of readmission of the patient to the current care level as an additional input in the computation of the two or more patient specific transition scores.

8. (canceled)

9. The clinical support system as claimed in claim 1, wherein the instructions further cause the processor to use patient population data providing statistical information on historic transitions of other patients between different care levels including information on improvements and/or deteriorations of their health status in response to said historic transitions.

10. The clinical support system as claimed in claim 1, wherein the instructions further cause the processor to compute one or more disease specific health scores for the patient from said current and historic patient data and to use said one or more disease specific health scores in the computation of said two or more patient specific transition scores.

11. The clinical support system as claimed in claim 1, wherein the instructions further cause the processor to obtain patient data, health progression information and/or transmission scores of patients that had the same or a similar health status and/or health history as the current patient and to use the obtained patient data health progression information and/or transmission scores in the computation of the two or more patient specific transition scores.

12. The clinical support system as claimed in claim 1, wherein the instructions further cause the processor
to compute a general health score for the current care level from historic patient data of patients that have been in the current care level,
to compute two or more general transition scores each indicating a level of recommendation of a transition of a patient from the current care level to a different care level or to stay in the current care level, and
to combine said two or more general transition scores with said two or more patient specific transition scores to obtain two or more final transition scores.

13. The clinical support system as claimed in claim 12, wherein the instructions further cause the processor to apply a weighted combination of said general transition scores and said patient specific transition scores to obtain said final transition scores, the weights being determined manually or from the accuracy of past transition scores of the current patient, other patients and/or all patients.

14. A clinical support method comprising the steps of
obtaining current patient data descriptive of a patient, for whom a recommendation for a transition from a current care levels to one or more other care levels shall be provided, in the current care level,
obtaining historic patient data of the patient obtained earlier in the current and/or other care levels, and
computing two or more patient specific transition scores from said obtained current and historic patient data, wherein a patient specific transition score indicates a level of recommendation of a transition of the patient from the current care level to a different care level or to stay in the current care level.

15. A computer-readable non-transitory storage medium containing instructions for execution by a processor, wherein the instructions cause the processor to perform the steps of:
obtaining current patient data descriptive of a patient, for whom a recommendation for a transition from a current care levels to one or more other care levels shall be provided, in the current care level,
obtaining historic patient data of the patient obtained earlier in the current and/or other care levels, and
computing two or more patient specific transition scores from said obtained current and historic patient data, a patient specific transition score indicating a level of recommendation of a transition of the patient from the current care level to a different care level or to stay in the current care level.

16. Computer program comprising program code means for causing a computer to carry out the steps of the method as claimed in claim 14 when said computer program is carried out on the computer.

17. A clinical support system comprising:
means for obtaining current patient data descriptive of a patient, for whom a recommendation for a transition from a current care levels to one or more other care levels shall be provided, in the current care level,
means for obtaining historic patient data of the patient obtained earlier in the current and/or other care levels, and
means for computing two or more patient specific transition scores from said obtained current and historic patient data, wherein a patient specific transition score indicates a level of recommendation of a transition of the patient from the current care level to a different care level or to stay in the current care level.
